(19) United States
(12) Patent Application Publication
(10) Pub. No.: US 2009/0247308 A1
(43) Pub. Date: Oct. 1, 2009

(54) UNIVERSAL JOINT

(75) Inventor: Murali M.R. Krishna, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company LLC, Warrenville, IL (US)

(21) Appl. No.: 12/056,878

(22) Filed: Mar. 27, 2008

(51) Int. Cl. F16D 3/00

(52) U.S. Cl. 464/125

(57) ABSTRACT

A universal joint (110) includes a first yoke (112) having a first arm (120) and a second arm (122), and a second yoke (114) having a third arm (130) and a fourth arm (132). A coupling member (116) having a ring-shaped body (138) is disposed between the first yoke (112) and the second yoke (114). The coupling member (116) has a central aperture (142) generally circumscribing a rotational axis (A-A) of the coupling member. A plurality of receiving portions (140) on the coupling member (116) are configured to receive the first arm (120), the second arm (122), the third arm (130) and the fourth arm (132).

### FIELD OF THE INVENTION

The present invention relates generally to a universal joint. More specifically, the present invention relates to a universal joint for use in any application where torque (mechanical power) transmission is involved.

### BACKGROUND OF THE INVENTION

A conventional universal joint is a joint between a drive shaft and a driven shaft that transmits torque or mechanical power via rotary motion. A universal joint is typically used between an engine of a vehicle and an axle of a vehicle. The drive shaft and the driven shaft do not need to be oriented 180-degrees from each other, but can be oriented at other angles and still transmit the rotary motion. The conventional universal joint includes a pair of opposing yokes that engage a cross-member located between the yokes. A typical cross-member is generally plus-shaped with a massive center and four distal ends. The points of attachment of the yokes to the cross member are oriented at 90° relative to each other.

A drawback of the conventional universal joint is that the joint is heavier than desired. Further, the location of a large portion of the weight of the universal joint is located at the center of the cross-member, which is inefficient for torque transmission. Another drawback of the conventional universal joint is that the joint weighs and costs more than desired because of the bulk of this material at the center.

### SUMMARY OF THE INVENTION

A universal joint includes a first yoke having a first arm and a second arm, and a second yoke having a third arm and a fourth arm. A coupling member having a ring-shaped body is disposed between the first yoke and the second yoke. The coupling member has a central aperture generally circumscribing a rotational axis of the coupling member. A plurality of receiving portions on the coupling member are configured to receive the first arm, the second arm, the third arm and the fourth arm.

### BRIEF DESCRIPTION OF THE DRAWINGS

FIG. 1 is a partially exploded, perspective view of a prior art universal joint.

FIG. 2 is a perspective view of the assembled prior art universal joint.

FIG. 3 is a partially exploded, perspective view of a universal joint in accordance with the invention.

FIG. 4 is a perspective view of the assembled universal joint in accordance with the invention.

### DESCRIPTION OF A PREFERRED EMBODIMENT

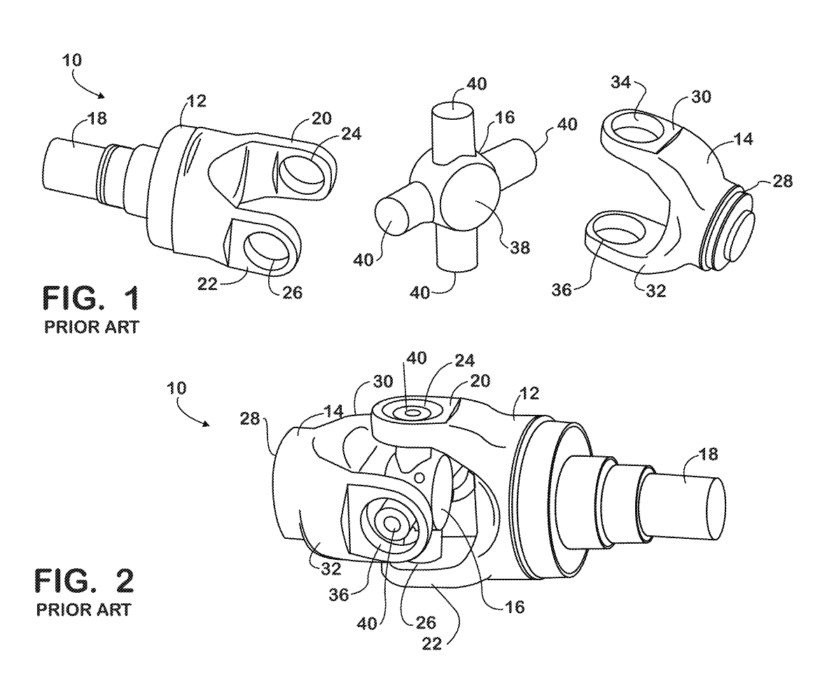

Referring to FIGS. 1-2, a prior art universal joint is depicted generally at 10, and includes a first yoke 12 and a second yoke 14 coupled to a cross member 16. The prior art universal joint 10 is configured for transmitting torque from a source, such as an engine (not shown) to a destination, such as a rear axle of a vehicle (not shown).

The first yoke 12 has a shaft portion 18, and extending from the shaft portion towards the cross-member 16 is a first arm 20 and a second arm 22. The first arm 20 and the second arm 22 have an aperture 24, 26. On the second yoke 14 extending from a shaft portion 28 towards the cross member 16, is a third arm 30 and a fourth arm 32. Both the third arm 30 and the fourth arm 32 also have a second aperture 34, 36.

The cross member 16 has a central portion 38 with four distal ends 40. The bulk of the mass of the cross member 16 is at the central portion 38. Each distal end 40 of the cross member 16 is received in the apertures 24, 26, 34, 36 of the arms 20, 22, 30, 32, and each aperture has one bearing (not shown) with a total of four bearings for each universal joint. When the shaft portion 18 is driven by the engine, the yoke 12 transfers torque to the cross member 16, via the bearings, and the cross member transfers torque to the second yoke 14. In this configuration, the shaft portion 18 drives the shaft portion 28 through the universal joint 10.

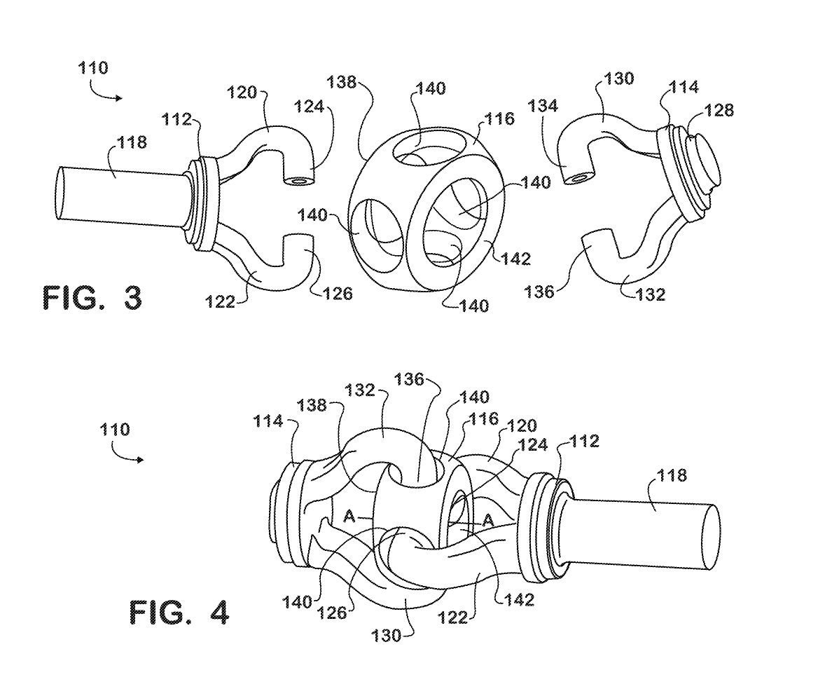

Referring now to FIGS. 3-4, the present universal joint is depicted generally at 110, and includes a first yoke 112 and a second yoke 114 attached to a coupling member 116. The universal joint 110 is configured for transmitting torque from a source, such as an engine (not shown) to a destination, such as a rear axle of a vehicle (not shown).

The first yoke 112 has a shaft portion 118, and extending from the shaft portion towards the coupling member 116 is a first arm 120 and a second arm 122. The first arm 120 and the second arm 122 each have an engaging portion 124, 126, which are advantageously pin-shaped projections. In the universal joint 110, the arms 120, 122 are generally curved and hook-like, although other configurations are contemplated. The engaging portions 124, 126 extend generally transversely to the shaft portion 118 and oppose each other. Each engaging portion 124, 126 engages the coupling member 116.

On the second yoke 114, extending from a shaft portion 128 is a third arm 130 and a fourth arm 132. Each of the third arm 130 and the fourth arm 132 have a second engaging portion 134, 136, generally similar to the engaging portion 124, 126 of the first yoke 112.

The coupling member 116 has a generally ring-shaped body 138 with four receiving portions. In the coupling member 116, the receiving portions are receiving apertures 140 spaced at generally 90-degree increments around the peripheral surface of the ring-shaped body 138, however other receiving portions are contemplated. The receiving apertures 140 are configured to receive the engaging portions 124, 126, 134, 136, with bearings (not shown) located between the engaging portions and the receiving apertures. When the shaft portion 118 is driven by the engine, the yoke 112 transfers torque to the coupling member 116, and the coupling member transfers torque to the second yoke 114, via the bearings. In this configuration, the shaft portion 118 drives the shaft portion 128 through the universal joint 110. The bearings (not shown) are advantageously used to maintain the yokes 112, 114 in the coupling member 116.

A center aperture 142 is formed in the ring-shaped body 138 and circumscribes a rotational axis “A-A” of the coupling member 116. With the ring-shaped body 138, the mass of the coupling member 116 is not centered on the rotational axis, but is offset a distance from the rotational axis “A-A”. Having the mass offset from the rotational axis “A-A”, such as in coupling member 116, is a more efficient arrangement for torque transmission than having the mass at the rotational axis, such as the prior art cross member 16.

Additionally, the ring-shaped body 138 provides the coupling member 116 with a symmetric shape about the rotational axis “A-A”, which makes the coupling member 116 suitable for torque transmission at both high and low speeds. Particularly at high torque transmission speeds, no secondary forces are generated due to the symmetric shape of the coupling member 116 and the yokes 112 and 114. Further, the coupling member 116 can transmit torque even when the shaft portions 118 and 128 are inclined to each other in any plane, while retaining all the degrees of freedom of rotation as the prior art universal joint 10.

For the same amount of torque transmission as the prior art universal joint 10, the present universal joint 110 has lighter yokes 112, 114 and a lighter coupling member 116. Further, with less material used for the universal joint 110, there is less material cost.

The present invention can be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A universal joint, comprising:
a first yoke having a first arm and a second arm;
a second yoke having a third arm and a fourth arm; and
a coupling member having a ring-shaped body disposed between the first yoke and the second yoke, said coupling member having four apertures disposed at generally 90-degree increments around the periphery of the ring-shaped body, wherein each of the four apertures are configured to receive one of the first arm, the second arm, the third arm and the fourth arm.

2. The universal joint of claim 1 wherein the first arm and the third arm are disposed in apertures generally 180-degrees from each other on the coupling member.

3. The universal joint of claim 1 wherein the coupling member further comprises a central aperture, wherein the central aperture circumscribes a rotational axis of the coupling member.

4. The universal joint of claim 1 wherein the first arm and the second arm each have an engaging portion configured to engage two of the four apertures.

5. The universal joint of claim 4 wherein the third arm and the fourth arm each have a second engaging portion configured to engage the other two of the four apertures.

6. The universal joint of claim 5 wherein the first arm, the second arm, the third arm, and the fourth arm are generally hook-shaped.

7. A universal joint, comprising:
a first yoke having a first arm and a second arm, each of the first and second arms having opposing first engaging portions;
a second yoke having a third arm and a fourth arm, each of the third and fourth arms having opposing second engaging portions; and
a coupling member having a ring-shaped body disposed between the first yoke and the second yoke, said coupling member having a central aperture and a plurality of peripheral apertures around the periphery of the ring-shaped body, wherein each of the peripheral apertures are configured to receive one of the first engaging portions and second engaging portions.

8. The universal joint of claim 7 further wherein the plurality of apertures comprises four apertures disposed at generally 90-degree increments.

9. The universal joint of claim 7 wherein the engaging portions are pin-shaped extensions that are configured to be received in the plurality of apertures.

10. The universal joint of claim 7 wherein the universal joint has no mass located at a rotational axis of the coupling member.

11. The universal joint of claim 7 wherein the coupling member is symmetric about a rotational axis of the coupling member.

12. The universal joint of claim 7 wherein the central aperture generally circumscribes the rotational axis of the coupling member.

13. The universal joint of claim 7 wherein the first arm, the second arm, the third arm, and the fourth arm are generally hook-shaped.

14. A universal joint, comprising:
a first yoke having a first arm and a second arm;
a second yoke having a third arm and a fourth arm; and
a coupling member having a ring-shaped body disposed between the first yoke and the second yoke, the coupling member having a central aperture generally circumscribing a rotational axis of the coupling member, and a plurality of receiving portions on the coupling member are configured to receive the first arm, the second arm, the third arm and the fourth arm.

15. The universal joint of claim 14 wherein the plurality of receiving portions comprise a plurality of apertures disposed on the peripheral surface of the ring-shaped body.

16. The universal joint of claim 15 wherein the plurality of apertures comprises four apertures disposed at generally 90-degree increments.

17. The universal joint of claim 15 wherein the first arm and the second arm each have a pin-shaped extension that is configured to be received in the plurality of apertures.

18. The universal joint of claim 14 wherein the universal joint has no mass located at the rotational axis of the coupling member.

19. The universal joint of claim 14 wherein the coupling member is symmetric about the rotational axis of the coupling member.

20. The universal joint of claim 14 wherein the first arm, the second arm, the third arm, and the fourth arm are generally hook-shaped.
